(19) United States
(12) Patent Application Publication
(10) Pub. No.: US 2013/0062582 A1
(43) Pub. Date: Mar. 14, 2013

(54) LAYERED OXIDE CATHODE MATERIALS FOR LITHIUM ION BATTERIES

(71) Applicants: Haitao Huang, Austin, TX (US); Yazid Saidi, Cedar Park, TX (US)

(72) Inventors: Haitao Huang, Austin, TX (US); Yazid Saidi, Cedar Park, TX (US)

(21) Appl. No.: 13/606,855

(22) Filed: Sep. 7, 2012

Related U.S. Application Data
(60) Provisional application No. 61/532,317, filed on Sep. 8, 2011.

(51) Int. Cl. H01B 1/08

(52) U.S. Cl. 252/521.2; 252/518.1

(57) ABSTRACT

A mixed metal oxide having the formula xLi₂MnO₃.(1−x)LiMO₂ formed efficiently and in a reduced number of steps by at least partially drying an aqueous metal hydroxide mixture to form a mixed metal precursor, and then reacting the mixed metal precursor to form the mixed metal oxide. The aqueous metal hydroxide mixture includes lithium, manganese, and one or more additional metals in stoichiometric proportions indicated by the formula xLi₂MnO₃.(1−x)LiMO₂, where 0<x<1 and M represents manganese and the one or more additional metals. In some cases, the aqueous metal hydroxide mixture is formed by preparing an aqueous metal salt solution including lithium, manganese, and the one or more additional metals in stoichiometric proportions indicated by the formula xLi₂MnO₃.(1−x)LiMO₂, and combining the aqueous metal salt solution with ammonium hydroxide to form the aqueous metal hydroxide mixture.

### PRIORITY CLAIM

This application claims priority to U.S. Patent Application No. 61/532,317 entitled “LAYERED OXIDE CATHODE MATERIALS FOR LITHIUM ION BATTERIES” filed on Sep. 8, 2011.

### TECHNICAL FIELD

This invention is related to a mixed metal oxide with a layered structure for use as a cathode material in lithium ion batteries.

### BACKGROUND

Layered metal oxides having the formula xLi₂MnO₃.(1−x)LiMO₂ have been made by a process that includes preparing a clear aqueous solution of mixed metal salts such as acetates or nitrates of manganese, cobalt, and nickel, and then precipitating a mixture of mixed metal hydroxides by adding an alkali metal hydroxide or carbonate. The precipitate is filtered, washed with water to remove the residual alkali metal, and then dried. The dried precipitate is mixed with a stoichiometric amount of lithium in the form of lithium hydroxide or lithium carbonate. The mixture is preheated, and ball milled to promote homogeneity. Finally, a solid state reaction is carried out at a temperature of about 900° C. to make a layered metal oxide product with the formula xLi₂MnO₃.(1−x)LiMO₂. These layered metal oxides have an O3 structure and have been used as cathode materials in lithium ion batteries.

### SUMMARY

In one aspect, a mixed metal oxide having the formula xLi₂MnO₃.(1−x)LiMO₂ is formed efficiently and in a reduced number of steps by at least partially drying an aqueous metal hydroxide mixture to form a mixed metal precursor, and then reacting the mixed metal precursor to form the mixed metal oxide. The aqueous metal hydroxide mixture includes lithium, manganese, and one or more additional metals in stoichiometric proportions indicated by the formula xLi₂MnO₃.(1−x)LiMO₂, where 0<x<1 and M represents manganese and the one or more additional metals.

Implementations include one or more of the following features. In some cases, the aqueous metal hydroxide mixture is formed by preparing an aqueous metal salt solution including lithium, manganese, and the one or more additional metals in stoichiometric proportions indicated by the formula xLi₂MnO₃.(1−x)LiMO₂, and combining the aqueous metal salt solution with ammonium hydroxide to form the aqueous metal hydroxide mixture. In certain cases, the mixed metal precursor is mechanically agitated before the mixed metal precursor is reacted.

Preparing the aqueous metal salt solution includes combining i) a manganese salt; ii) lithium hydroxide, a lithium salt, or a combination thereof; and iii) one or more additional metal salts in aqueous media. The one or more additional metal salts may include, for example, a nickel salt, a cobalt salt, an iron salt, an aluminum salt, or any combination thereof. The manganese salt may include manganese acetate, manganese nitrate, manganese carbonate, manganese oxalate, or a combination thereof. The lithium salt may include lithium acetate, lithium nitrate, lithium carbonate, lithium oxalate, or a combination thereof. The one or more additional metal salts may include acetates, nitrates, carbonates, oxalates, or a combination thereof.

In some cases, combining the aqueous metal salt solution with ammonium hydroxide includes combining the aqueous metal salt solution with an aqueous ammonium hydroxide solution. At least partially drying the aqueous metal hydroxide mixture may include removing water from the aqueous metal hydroxide mixture. In some cases, at least partially drying the aqueous metal hydroxide mixture includes forced evaporation of water from the aqueous metal hydroxide mixture. In some examples, at least partially drying the aqueous metal hydroxide mixture includes spray drying the aqueous metal hydroxide mixture, freeze drying the aqueous metal hydroxide mixture, drum drying the aqueous metal hydroxide mixture, or rotary evaporation of the aqueous metal hydroxide mixture. At least partially drying the aqueous metal hydroxide mixture may include heating the aqueous metal hydroxide mixture, for example, to a temperature not exceeding 600° C.

In some cases, reacting the mixed metal precursor comprises heating the mixed metal precursor in a high temperature furnace. In an example, reacting the mixed metal precursor includes heating the mixed metal precursor to a temperature of at least 700° C.

In some implementations, the aqueous metal hydroxide mixture and the mixed metal precursor are free of added sodium and potassium compounds. The mixed metal oxide is formed in the absence of filtration and/or in the absence of washing.

In some cases, forming the mixed metal oxide consists essentially of at least partially drying the aqueous metal hydroxide mixture and reacting the mixed metal precursor. In certain cases, forming the mixed metal oxide consists essentially of preparing the aqueous metal salt solution, combining the aqueous metal salt solution with ammonium hydroxide, at least partially drying the aqueous metal hydroxide mixture, and reacting the mixed metal precursor. In other cases, forming the mixed metal oxide consists essentially of preparing the aqueous metal salt solution, combining the aqueous metal salt solution with ammonium hydroxide, at least partially drying the aqueous metal hydroxide mixture, mechanically agitating the mixed metal precursor, and reacting the mixed metal precursor.

Advantages of the method described herein include forming an aqueous mixture including lithium, manganese, and one or more additional metals in the stoichiometric proportions indicated by formula xLi₂MnO₃.(1−x)LiMO₂. By eliminating precipitation, filtering, and washing of intermediate compositions, efficiency and cost-effectiveness are improved, and loss of soluble components is substantially eliminated. As such, the desired and originally established stoichiometric proportions are maintained. In addition, contaminants (e.g., sodium ions from sodium hydroxide or sodium carbonate, potassium ions from potassium hydroxide or potassium carbonate, and the like) are not introduced.

These general and specific aspects may be implemented using a device, system or method, or any combination of devices, systems, or methods. The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a flow chart showing a process of making mixed metal oxide having the formula xLi₂MnO₃.(1−x)LiMO₂.

FIG. 2 shows an X-ray diffraction pattern of Li_{1.167}Mn_{0.558}Ni_{0.225}Al_{0.05}O₂ formed as described in Example 1.

FIG. 3 shows a plot of capacity vs. charging rate for Li_{1.184}Mn_{0.569}Ni_{0.202}Co_{0.045}O₂.

FIG. 4 shows an X-ray diffraction pattern of Li_{1.17}Mn_{0.558}Ni_{0.225}Al_{0.025}Fe_{0.025}O₂ formed as described in Example 4.

### DETAILED DESCRIPTION

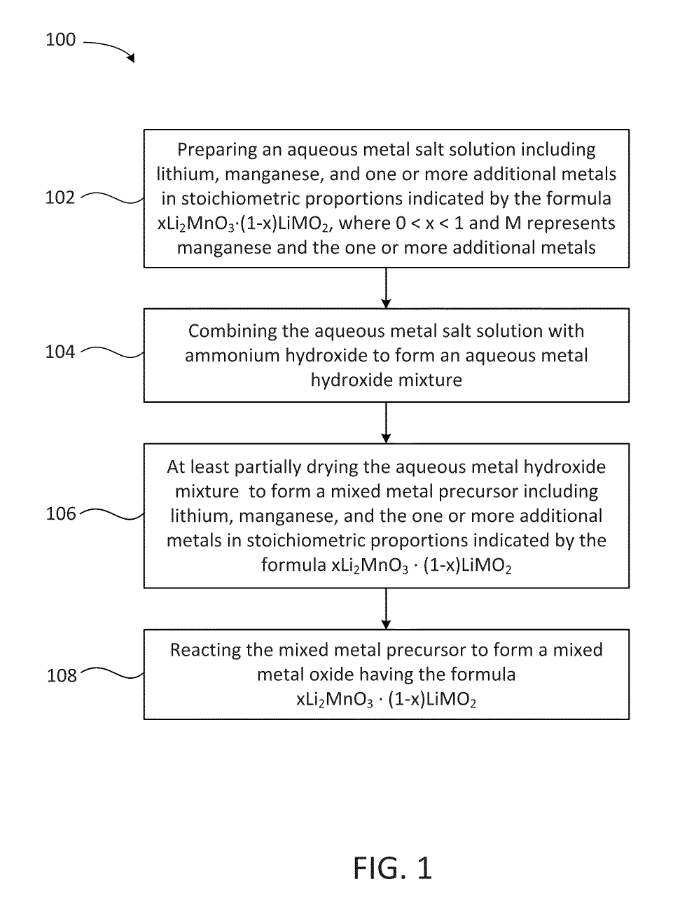

Referring to FIG. 1, process 100 for making a mixed metal oxide having the O3 structure of LiCoO₂ includes preparing an aqueous metal salt solution including metals in the stoichiometric proportions of the desired metal oxide (102). An aqueous metal hydroxide mixture is formed by adding ammonium hydroxide to the aqueous metal salt solution (104). The aqueous metal hydroxide mixture is at least partially dried to form a mixed metal precursor (106), and the mixed metal precursor is reacted to form the mixed metal oxide (108).

In 102, an aqueous metal salt solution including lithium, manganese, and one or more additional metals in stoichiometric proportions indicated by the formula xLi₂MnO₃.(1−x)LiMO₂ is prepared, where 0<x<1 and M represents manganese and the one or more additional metals. Preparing the aqueous metal salt solution includes combining metal compounds including a lithium compound, a manganese compound, and one or more additional metal compounds in aqueous media (e.g., water, an aqueous solution, or an aqueous mixture). In some cases, the aqueous media includes one or more additives, including surfactants such as polyethylene glycol (PEG) and DuPont ZONYL fluorosurfactants. The metal compounds may be metal hydroxides or metal salts, such as metal acetates, metal nitrates, metal carbonates, metal oxalates, or any combination thereof. As used herein, a “metal salt” generally refers to a metal salt or any hydrate thereof. The metal compounds may be soluble in water or have limited solubility in water. As such, the aqueous metal salt solution may be a homogenous solution, or may include some undissolved metal compounds in equilibrium with a homogenous solution. As used herein, “aqueous metal salt solution” generally refers to a homogenous metal salt solution and as well as any undissolved metal compounds in equilibrium with the homogenous metal salt solution. In some cases, the metal compounds account for up to 30 wt % of the aqueous metal salt solution.

The lithium compound used to form the aqueous metal salt solution in 102 may be, for example, lithium hydroxide, a lithium salt (e.g., lithium acetate, lithium nitrate, lithium carbonate, lithium oxalate), or a combination thereof. The manganese compound used to form the aqueous metal salt solution in 102 may be, for example, manganese acetate, manganese nitrate, manganese carbonate, or manganese oxalate. The one or more additional metal compounds are not limited, and may include transition metal or other metal compounds such as, but not limited to, salts (e.g., acetates, nitrates, carbonates, or oxalates) of nickel, cobalt, aluminum, iron, magnesium, chromium, vanadium, and calcium.

In 104, the aqueous metal salt solution is combined with ammonium hydroxide to form an aqueous metal hydroxide mixture including hydroxides of lithium, manganese, and the one or more additional metals in stoichiometric proportions indicated by the formula xLi₂MnO₃.(1−x)LiMO₂. In some cases, combining the aqueous metal salt solution with ammonium hydroxide includes combining the aqueous metal salt solution with a basic solution formed by dissolving ammonium hydroxide in water. The concentration of the ammonium hydroxide solution may be in a range between 10 wt % and 50 wt % (e.g., 20 wt % or 28 wt %). The amount of hydroxide added may be in excess (e.g., 5% excess, 10% excess, or 15% excess) of the amount needed to form metal hydroxides from the metals in the aqueous metal salt solution, such that substantially all of the metal in the aqueous metal salt solution reacts or is converted to form mixed metal hydroxides. In some cases, the aqueous metal hydroxide mixture includes aqueous media in equilibrium with precipitated mixed metal hydroxides. In certain cases, the aqueous metal hydroxide mixture is a sol, with the mixed metal hydroxides suspended in the aqueous media. Forming a sol may be achieved, for example, by combining one or more additives (e.g., a gelling agent such as citric acid) with the ammonium hydroxide solution or the aqueous metal salt solution.

The aqueous metal hydroxide mixture is not filtered or washed (e.g., with aqueous media, alcohols, or other solvents). As such, the quantity and stoichiometric proportions of the metals in the aqueous metal salt solution (and thus the aqueous metal hydroxide mixture) are not altered by loss through filtration or washing of the soluble metal complexes. The use of ammonium hydroxide to form the aqueous metal hydroxide mixture, rather than, for example, hydroxides of alkali metals such as sodium, lithium, or potassium, allows formation of the aqueous metal hydroxide mixture in the absence of ions that are typically removed (e.g., by washing). In some cases, the aqueous metal hydroxide mixture from 104 may be prepared and stored before further use. In certain cases, the aqueous metal hydroxide mixture from 104 may be shipped or transported before further processing.

In 106, the aqueous metal hydroxide mixture is at least partially dried to form a mixed metal precursor. As used herein, “at least partially dried” generally refers to removing a majority of the water (e.g., at least 60%, at least 70%, at least 80%, at least 90%, or at least 95%) from the aqueous hydroxide mixture. Metals in the mixed metal precursor are present in the stoichiometric proportions indicated by the formula xLi₂MnO₃.(1−x)LiMO₂. The mixed metal precursor is not filtered or washed (e.g., with aqueous media, alcohols, or other solvents). As such, the quantity and stoichiometric proportions of the metals in the mixed metal precursor are substantially the same as the stoichiometric proportions of the metals in the aqueous metal salt solution and the aqueous metal hydroxide mixture.

At least partially drying the aqueous metal hydroxide mixture may include removing water from the aqueous metal hydroxide mixture in a process including forced evaporation. In some cases, at least partially drying the aqueous metal hydroxide mixture includes spray drying the mixture or pre-drying the mixture followed by rotary evaporation. In certain cases, at least partially drying the aqueous metal hydroxide mixture includes heating the mixture to a temperature less than the temperature at which components would begin to react. For example, the mixture may be heated (e.g., in a high temperature furnace) to a temperature up to (i.e., not exceeding) 200° C., 300° C., 400° C., 500° C., or 600° C.

In 108, the mixed metal precursor is reacted to form a mixed metal oxide having the formula xLi₂MnO₃.(1−x)LiMO₂, where 0<x<1 and M represents manganese and the one or more additional metals. Reacting the mixed metal precursor may include heating the mixed metal precursor at a temperature and for a length of time sufficient for a solid state reaction to occur, thereby forming the mixed metal oxide from the mixed metal precursor. In some examples, reacting the mixed metal precursor includes heating the mixed metal precursor in air to a temperature of at least 700° C., at least 800° C., or at least 900° C. The mixed metal precursor may be heated for a length of time in a range of about 1 hour to about 10 hours (e.g., about 4 hours, about 6 hours, or about 8 hours).

In some implementations, the mixed metal precursor from 106 is mechanically agitated before it is reacted in 108. Mechanical agitation may promote deagglomeration and homogenization of the mixed metal precursor. Examples of mechanical agitation include, but are not limited to, ball milling, jar milling, vibratory milling, and the like. In some cases, including a surfactant as an additive (e.g., in the aqueous metal salt solution) inhibits agglomeration of the mixed metal precursor, thereby reducing or eliminating the need for mechanical agitation.

Advantages of process 100 include forming an aqueous mixture including lithium, manganese, and one or more additional metals in the stoichiometric proportions indicated by formula xLi₂MnO₃.(1−x)LiMO₂. By eliminating precipitation, filtering, and washing of intermediate compositions, efficiency and cost-effectiveness are improved. In addition, process 100 eliminates the introduction of contaminants (e.g., sodium ions from sodium hydroxide or sodium carbonate, potassium ions from potassium hydroxide or potassium carbonate, and the like) and the subsequent removal thereof.

### EXAMPLES

### Example 1

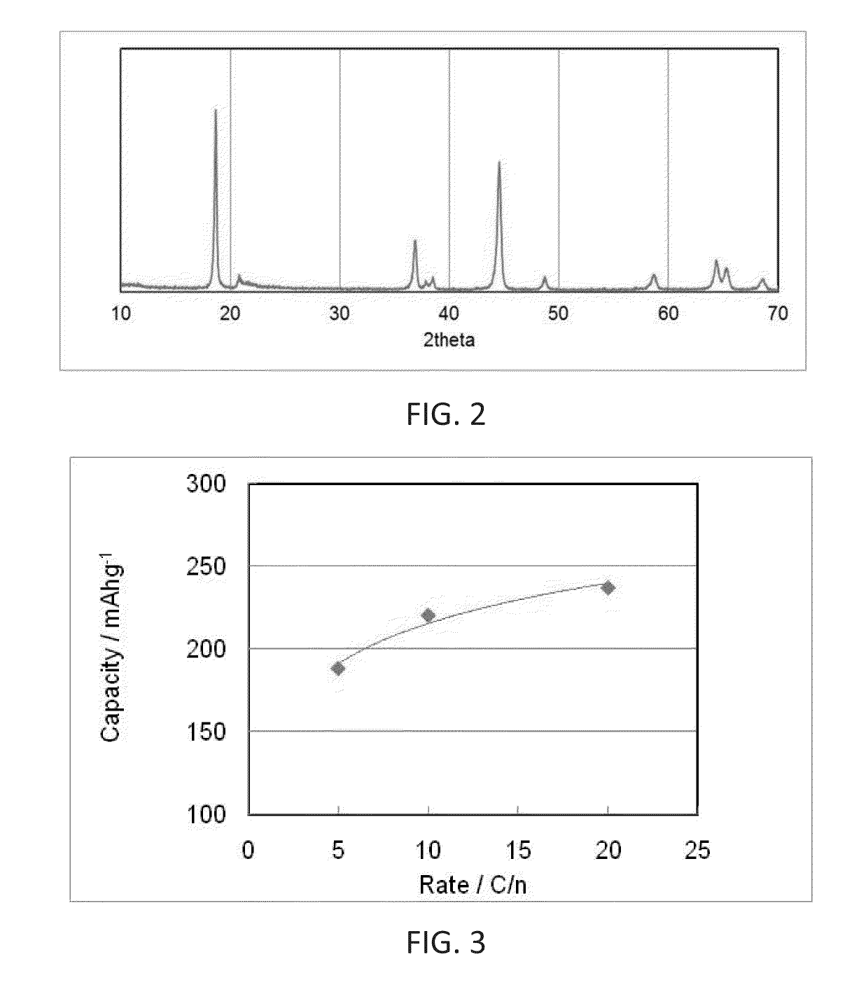

5 g of Mn(CH₃COO)₂.4H₂O (22% Mn, Alfa Aesar), 2.0501 g of Ni(CH₃COO)₂.4H₂O (98%, Alfa Aesar), 0.6867 g of Al(NO₃)₃.9H₂O (98%, Alfa Aesar) and 4.3262 g of LiCH₃COO.2H₂O (99%, Alfa Aesar) were all dissolved in about 80 mL of deionized water with stirring, and then added into 25 mL of NH₄OH solution containing 6.3 g of NH₄OH (28% NH₃, Alfa Aesar). The resulting mixture was heated to remove water and further dried at 400° C. followed by ball milling. The mixture was then fired at 800° C. for 6 hours in air. An X-ray diffraction pattern (Cu target) of the resulting Li_{1.167}Mn_{0.558}Ni_{0.225}Al_{0.05}O₂ is shown in FIG. 2, indicating an O3 type structure.

### Example 2

5 g of Mn(CH₃COO)₂.4H₂O (22% Mn, Alfa Aesar), 1.6731 g of Ni(CH₃COO)₂.4H₂O (98%, Alfa Aesar), 0.4045 g of Co(CH₃COO)₂.4H₂O (24% Co, Alfa Aesar), 0.6305 g of Al(NO₃)₃.9H₂O (98%, Alfa Aesar), and 4.466 g of LiCH₃COO.2H₂O (99%, Alfa Aesar) were all dissolved in about 80 mL of deionized water with stirring, and then added into 25 mL of a NH₄OH solution containing 6.4 g of NH₄OH (Alfa 28% NH₃). The resulting mixture was heated to remove water and further dried at 400° C. followed by ball milling. The mixture was then fired at 800° C. for 6 h in air to form Li_{1.184}Mn_{0.547}Ni_{0.18}Co_{0.045}Al_{0.045}O₂.

### Example 3

5 g of Mn(CH₃COO)₂.4H₂O (22% Mn, Alfa Aesar), 1.8050 g of Ni(CH₃COO)₂.4H₂O (98%, Alfa Aesar), 0.3888 g of Co(CH₃COO)₂.4H₂O (24% Co, Alfa Aesar), and 4.2933 g of LiCH₃COO.2H₂O (99%, Alfa Aesar) were all dissolved in about 80 mL of deionized water with stirring, and then added into 25 mL of NH₄OH solution containing 6.4 g of NH₄OH (28% NH₃, Alfa Aesar). The resulting mixture was heated to remove water and further dried at 400° C., followed by ball milling. The mixture was then fired at 800° C. for 6 h in air to form Li_{1.184}Mn_{0.569}Ni_{0.202}Co_{0.045}O₂. The capacity of Li_{1.184}Mn_{0.569}Ni_{0.202}Co_{0.045}O₂ was tested in a half cell. FIG. 3 shows the capacity of this metal oxide (mAh/g) at rates from 5 to 20 C/n. The current used for charging was the same as that used for discharging. The current is based on the projected discharge (or charge) capacity of the material. A C-rate, for example, generally refers to the current required to discharge the full available capacity of the cell in one hour. Thus, C/5 is equivalent to a 1/(C/5) or a discharge time of 5 hours.

### Example 4

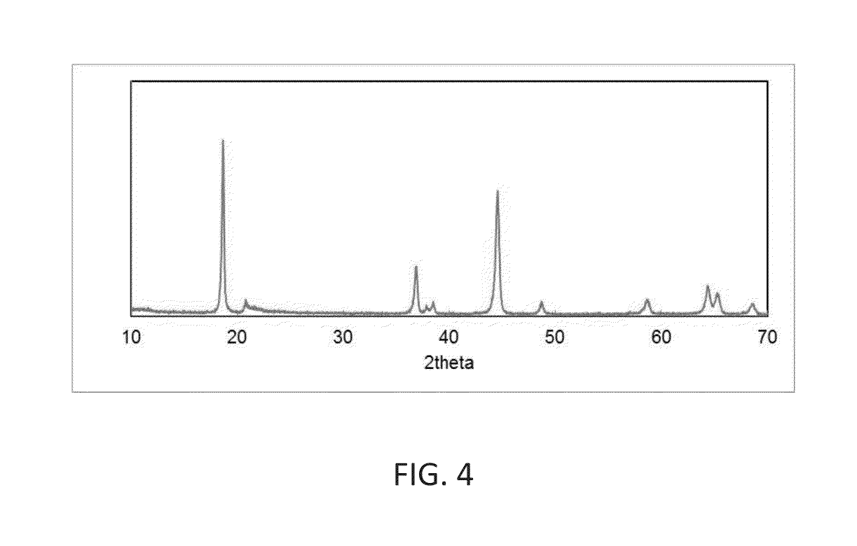

0.0503 g of Fe powder (99.5%, Aldrich) was reacted with 2 g acetic acid by heating, and about 15 mL of deionized water added to form an iron solution. 2 to 3 drops of nitric acid was added to inhibit precipitation of iron. 5 g of Mn(CH₃COO)₂.4H₂O (22% Mn, Alfa Aesar), 2.0501 g of Ni(CH₃COO)₂.4H₂O (98%, Alfa Aesar), 0.3434 g of Al(NO₃)₃.9H₂O (98%, Alfa Aesar) and 4.3262 g of LiCH₃COO.2H₂O (99%, Alfa Aesar) were all dissolved in about 50 mL of deionized water with stirring. This solution was mixed with the iron solution, and the mixture was added into 25 mL of NH₄OH solution containing 6.4 g of NH₄OH (28% NH₃, Alfa Aesar). The resulting mixture was heated to remove water and further dried at 400° C., followed ball milling. The mixture was then fired at 800° C. for 6 hours in air to form Li_{1.17}Mn_{0.558}Ni_{0.225}Al_{0.025}Fe_{0.025}O₂. An X-ray diffraction pattern (Cu target) of the resulting Li_{1.17}Mn_{0.558}Ni_{0.225}Al_{0.025}Fe_{0.025}O₂ is shown in FIG. 4, indicating an O3 type structure.

A number of embodiments have been described. Nevertheless, it will be understood that various modifications may be made without departing from the spirit and scope of this disclosure. Accordingly, other embodiments are within the scope of the following claims. Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

1. A method comprising:
at least partially drying an aqueous metal hydroxide mixture to form a mixed metal precursor, the aqueous metal hydroxide mixture comprising lithium, manganese, and one or more additional metals in stoichiometric proportions indicated by the formula xLi₂MnO₃.(1−x)LiMO₂, where 0<x<1 and M represents manganese and the one or more additional metals; and
reacting the mixed metal precursor to form a mixed metal oxide having the formula xLi₂MnO₃.(1−x)LiMO₂.

2. The method of claim 1, further comprising:
preparing an aqueous metal salt solution comprising lithium, manganese, and the one or more additional metals in stoichiometric proportions indicated by the formula xLi₂MnO₃.(1−x)LiMO₂; and
combining the aqueous metal salt solution with ammonium hydroxide to form the aqueous metal hydroxide mixture.

3. The method of claim 2, wherein preparing the aqueous metal salt solution comprises combining i) a manganese salt; ii) lithium hydroxide, a lithium salt, or a combination thereof; and iii) one or more additional metal salts in aqueous media.

4. The method of claim 3, wherein the one or more additional metal salts comprise a nickel salt.

5. The method of claim 4, wherein the one or more additional metal salts further comprise a cobalt salt, an iron salt, an aluminum salt, or any combination thereof.

6. The method of claim 3, wherein the manganese salt comprises manganese acetate, manganese nitrate, manganese carbonate, manganese oxalate, or a combination thereof.

7. The method of claim 3, wherein the lithium salt comprises lithium acetate, lithium nitrate, lithium carbonate, lithium oxalate, or a combination thereof.

8. The method of claim 3, wherein the one or more additional metal salts comprise acetates, nitrates, carbonates, oxalates, or a combination thereof.

9. The method of claim 2, wherein combining the aqueous metal salt solution with ammonium hydroxide comprises combining the aqueous metal salt solution with an aqueous ammonium hydroxide solution.

10. The method of claim 1, wherein at least partially drying the aqueous metal hydroxide mixture comprises removing water from the aqueous metal hydroxide mixture.

11. The method of claim 1, wherein at least partially drying the aqueous metal hydroxide mixture comprises forced evaporation of water from the aqueous metal hydroxide mixture.

12. The method of claim 1, wherein at least partially drying the aqueous metal hydroxide mixture comprises spray drying the aqueous metal hydroxide mixture, freeze drying the aqueous metal hydroxide mixture, drum drying the aqueous metal hydroxide mixture, or rotary evaporation of the aqueous metal hydroxide mixture.

13. The method of claim 1, wherein at least partially drying the aqueous metal hydroxide mixture comprises heating the aqueous metal hydroxide mixture.

14. The method of claim 13, wherein at least partially drying the aqueous metal hydroxide mixture comprises heating the aqueous metal hydroxide mixture to a temperature not exceeding 600° C.

15. The method of claim 1, wherein reacting the mixed metal precursor comprises heating the mixed metal precursor in a high temperature furnace.

16. The method of claim 1, wherein reacting the mixed metal precursor comprises heating the mixed metal precursor to a temperature of at least 700° C.

17. The method of claim 1, wherein the aqueous metal hydroxide mixture is free of added sodium and potassium compounds.

18. The method of claim 1, wherein the mixed metal oxide is formed in the absence of filtration and/or in the absence of washing.

19. The method of claim 1, wherein the method consists essentially of at least partially drying the aqueous metal hydroxide mixture and reacting the mixed metal precursor.

20. The method of claim 1, wherein the method consists essentially of preparing the aqueous metal salt solution, combining the aqueous metal salt solution with ammonium hydroxide, at least partially drying the aqueous metal hydroxide mixture, and reacting the mixed metal precursor.

21. The method of claim 1, further comprising mechanically agitating the mixed metal precursor before reacting the mixed metal precursor.

22. The method of claim 21, wherein the method consists essentially of preparing the aqueous metal salt solution, combining the aqueous metal salt solution with ammonium hydroxide, at least partially drying the aqueous metal hydroxide mixture, mechanically agitating the mixed metal precursor, and reacting the mixed metal precursor.
